(19) United States
(12) Patent Application Publication
(10) Pub. No.: US 2022/0159915 A1
(43) Pub. Date: May 26, 2022

(54) PLANT POT TRAY AND IRRIGATION SYSTEM AND RELATED METHODS

(71) Applicant: COUNTRY PLASTICS, INC., Woodlake, CA (US)

(72) Inventor: Jay Ayres, Woodlake, CA (US)

(21) Appl. No.: 16/953,341

(22) Filed: Nov. 20, 2020

(51) Int. Cl. A01G 9/029; A01G 9/04; A01G 27/00

(52) U.S. Cl. CPC A01G 9/0295; A01G 27/008; A01G 9/045

(57) ABSTRACT

The present invention provides a plant pot tray and irrigation system that improves the efficiency of installation and removal of growing pots from the tray. The present invention includes a plant pot tray that includes an integrated irrigation system that does not install into the individual pots but may be installed into the tray itself outside of the pots. The integrated irrigation system allows for the pots to be installed and removed from the plant pot tray without disturbing the integrated irrigation system, thus making the installation and removal of the pots efficient and operable to be automated.

### FIELD OF THE INVENTION

The present invention relates generally to plant pot holder tray and irrigation in particular a tray having receptacles for plant-growing pots placed therein, and an integrated irrigation system. More particularly, the present invention includes removable pots and removable irrigation units that are exterior to the pots, allowing the pots to be removed without removal of the irrigation units.

### BACKGROUND OF THE INVENTION

Plant trays that accommodate several growing pots are commonly used in horticultural growing operations for housing and transport of flowering and non-flowering plants. Common problems with these systems include the removability of the pots once the plants have begun growing, even irrigation in the pots, and maintenance of the irrigation systems for the pots. Conventional systems result in significant amounts of manual labor to remove the growing pots from the trays to transport the growing plants. Typically, irrigation bubblers or small sprinkler devices are installed directly into the soil of the pots in order to ensure that the growing plant received adequate water. However, this results in a time-consuming process when the pots need to be removed from the trays.

Additionally, conventional bubblers and sprinklers used to irrigate the pots are inefficient and provide poor coverage, requiring the irrigation device to be positioned directly in the pot next to the growing plant. Improved emitter arrangements that provide efficient water use are needed for large scale growing operations that utilize large numbers of pots for multiple reasons. A reduction in the number of emitters will reduce the cost of the equipment and reduce the amount of maintenance work required. Also, more efficient emitters will reduce water usage and cost.

Improved growing pot and irrigation systems are needed to address the shortcomings of existing plant pot growing systems.

### SUMMARY OF THE INVENTION

The present invention provides a plant pot tray and irrigation system that improves the efficiency of installation and removal of growing pots from the tray. The present invention includes a plant pot tray that includes an integrated irrigation system that does not install into the individual pots but may be installed into the tray itself outside of the pots. The integrated irrigation system allows for the pots to be installed and removed from the plant pot tray without disturbing the integrated irrigation system, thus making the installation and removal of the pots efficient and operable in some embodiments to be automated.

The present invention provides a plant pot holder tray for retaining multiple pots for plants therein, with the receptacles for receiving the pots (e.g., two to 12 pots). In some embodiments, the trays may have a plurality of receivers for plant pots, arranged in rows. For example, the trays may include 2 or more rows, each of which may include 2 or more receivers each operable to receive a plant pot. In some embodiments, the receiver may have a pre-determined shape and depth that is complementary to a particular design of plant pot, thus allowing the fit and protrusion height of the installed pots is pre-determined and known. Each receiver may include a side wall portion and a base wall portion. The side wall portion and the base wall portion may be shaped and sized such that they are complementary to shape of the corresponding insertable plant pot. In some embodiments, the plant pot tray of the present invention enables variously sized plant pots to be securely retained within the receptacles, as the receivers may have a tapered profile that is operable to receive pots of different designs that have tapering perimeter shape.

The trays may also include irrigation connection structures at pre-determined location in the upper frame of the tray allowing for the attachment of irrigation devices thereto. In some embodiments, the irrigation connection structures may be positioned at nodes in the upper frame of the tray between rows of receivers where the corners of four receivers meet. The placement of the irrigation connection structures at these nodes allows the irrigation devices to be positioned such that they can deliver water to four pots at a time, maximizing the efficiency of each irrigation device and minimizing the number of the irrigation devices required to deliver water to the installed pots. The irrigation connection structures may be formed as a cut out structure with criss-crossing beams (e.g., a 90° angles) that allow the irrigation devices to be installed at multiple rotation orientations relative to the tray and pots. For example, the irrigation device may be optionally installed at any of four rotational options angularly spaced at 90° from one another. In other embodiments, the irrigation connector may have a single beam allowing for two orientations (i.e., opposite 180° orientations). In further embodiments, the irrigation connector may have more than two beams allowing for greater than four angular orientations.

In further embodiments, the irrigation connection structures may have other constructions. For example, the irrigation connection structures may include circular holes for accepting complementary male end of the irrigation device. The male end of the irrigation device may have a compressible material around its exterior to allow for a tight, pressure fit. The male end of the irrigation device may alternative or additionally include flexible tabs with barbs for holding the irrigation device within the irrigation connection structure. The barbs may pass through the irrigation connection structure and catch on the distal side of thereof to prevent pullout. In such embodiments, the irrigation connection structure may allow for the irrigation device to be positioned at any angular orientation relative to the pots and tray. Other irrigation connection structures are contemplated in the scope of the present invention.

The irrigation devices may include a complementary connector that engages with the irrigation connection structures, a riser, and a fluid emitting device operable to connect to the upper end of the riser. The connector allows the irrigation device to be positioned at the irrigation connection structures at the nodes between the corners of the pots. In some embodiments, the system may include an adapter clip that has an adaptable connector structure designed to fit the horizontal beams of various tray designs and a connection point for the complementary connector of the riser that protrudes upward from the adapter clip. The adapter clip allows the riser to be connected to pot trays of other designs. The adaptable connector may have a plurality of inferiorly protruding tabs (e.g., two or more) that are operable to pressure fit around the beams of the tray or cut-out structures in the beams of the tray. In some embodiments, the tabs of the adaptable connector may be flexible and resilient such that they can pressure fit around beams and other structures of varying diameters (e.g., in a range of about ⅛ inch to about 1 inch).

The riser may have a predetermined length that is sufficient to rise above the pots installed in the tray by a distance in a range of about 1 inch to about 4 inches. In some embodiments, the riser may have a height that allows the fluid emitting device to be positioned above various pot designs that are operable to be inserted into receivers. The riser may have an internal conduit for passing fluid. The riser may also include one or more irrigation tube fittings (e.g., a barbed fitting) for connecting to irrigation tubing or a pipe for delivering fluid. The irrigation tube fittings may be in fluid communication with the internal conduit of the riser, such that when irrigation tubing or pipe is connected to the one more irrigation tube fittings. Fluid can be delivered via the tubing or pipe to the irrigation tube fittings and then through the riser to the upper end of the riser. The irrigation tube fittings may be positioned on the riser such that the tubing can be run along the frame (e.g., beams of the tray) and connect with the fittings in a manner that avoids obstruction of removal and insertion of pots into the receivers therefor. The fittings may be positioned on the riser at or near the inferior end thereof and may also be positioned such that when the complementary connector of the riser is connected to the irrigation connection structures of the tray, the tube fittings are aligned with frame members of the tray and do not traverse the receivers for the pots.

A fluid emitting device may be attached to the upper end of each riser to receiver and distribute the fluid. The fluid emitting devices may each be operable to connect to the upper end of the riser in order to position the fluid emitter. The irrigation emitters connect to the riser by various mechanisms. In some embodiments, the emitter may connect to the upper end of the riser by a threaded connector to provide a substantially fluid-tight seal to prevent leakage. Various emitter types may be used, including bubblers, adjustable flow emitters, vortex emitters, and other types. In some embodiments, the irrigation emitter may include one or more flow deflectors. The irrigation emitters may have one or more bores that direct fluid flow toward the deflector in order to divide the fluid flow into multiple streams. The deflector may be positioned on an underside of an overhanging gantry structure of the irrigation emitter such that an upward flow from the one or more bores strikes the deflector. The deflector may be shaped to deflect the fluid flow in multiple directions to provide a desired flow pattern.

The deflector may include multiple protrusions and/or facets that divide the fluid flow from the bore into multiple deflected directions. The deflector may vary in its surface pattern and facets in order to produce different flow patterns, including variations on the number of streams, different angles of streams with respect both the vertical and horizontal dimensions, and other considerations. In one embodiment, the flow deflector may create four streams spaced by 90° from each other to facilitate fluid flow into four pots arranged in a grid pattern in the tray, and allow a single emitter to provide water or other fluid to four pots. In other embodiments, the deflector may have a surface that creates another number of spray patterns (e.g., 2, 3, 6 streams) to allow for providing water and/or other fluids to a different number of pots.

In some embodiments, the emitter may include a slot or other recess into which the deflector may be inserted. The gantry structure of the emitter may have a slot or recess over the one or more bores in the base of the emitter to allow the deflector to be positioned directly over the one or more bores. The invention may include multiple deflector designs with different facet and surface feature configurations that produce different numbers of fluid streams (e.g., 2, 3, 4, 6, or other numbers of streams). Additionally, the deflector designs may vary in the angle of the streams with respect to the horizontal dimension in order to accommodate pots of different heights. A flatter angle of a stream can clear the sidewall of a pot that sits higher in the tray. The interchangeable deflectors allows for changing the stream pattern without changing out the emitters.

The resulting growing pot tray and integrated irrigation system can be used without the need to remove the irrigation when adding, removing, or changing out the pots because the irrigation system is mounted outside of the pots and has a compact structure that does not horizontally overlap with the pots. Thus, the emitters and other structures of the integrated irrigation system do not obstruct insertion or removal of the pots into the tray. This greatly increases the efficiency of inserting and removing growing pots for each crop of greenhouse plants grown in the system, saving great amounts of man hours in the process.

These and other objects, advantages, purposes and features of this invention will become apparent upon review of the following specification in conjunction with the drawings.

In one aspect, the invention relates to a plant pot tray system comprising a plurality of receptacles in a tray, each operable to hold a plant pot, at least one connection point formed on a structural member of the tray between the plurality of receptacles, an integrated irrigation system having at least one irrigation assembly comprising, a riser having a connection mechanism operable to connect to at least one connection point an emitter operable to connect to an upper end of the riser, wherein the emitter has bore providing a stream of fluid directed at a deflector having a surface pattern that diverts the stream into a plurality of deflected streams in a pre-determined pattern that delivers fluid to the plurality of receptacles or plant pots installed in the receptacles. The emitter includes at least one bore for delivering a stream of fluid. The emitter may include a gantry structure overhanging the at least one bore and a deflector structure having a patterned surface. The bore may be aligned with the deflector such that the stream of fluid strikes the deflector. The pattern surface may include a plurality of facets that divert the stream of fluid into a plurality of deflected streams. The deflector may be removably inserted in a recess in the gantry structure, and the system includes a plurality of interchangeable deflectors with different patterned surfaces. The plurality of deflected streams may be individually directed toward one of the plurality of receptacles. The riser may further comprise at least one irrigation conduit connector that may be aligned with a structural member of the tray. The plant pot tray may further comprise an irrigation conduit in fluid communication with at least one irrigation conduit connector, the irrigation conduit may not traverse any of the plurality of receptacles and may not otherwise obstruct an opening in the receptacles for insertion of the plant pot, an adapter clip for attachment to upper structural members of the tray and having an upper connection structure operable to couple with the connection mechanism of the riser, the adapter clip may include flexible, resilient tabs operable to pressure fit on structural members of various diameters, providing an adaptable device for connecting the riser to planter trays of various designs. The adapter clip may include paired extensions having a tapering diameter between them to allow for pressure fitting on structural members of various diameters, providing an adaptable device for connecting the riser to planter trays of various designs. The riser may have a sufficient height to be positioned above the plant pot when the riser is attached to the connection point and the plant pot is inserted one of the receptacles. at least one connection point may be located at a node of an upper cross-beams of the tray between two or more of the plurality of receptacles.

In another aspect, the invention relates to a plant pot tray with an integrated irrigation system comprising: a plurality of receptacles in a tray, each operable to hold a plant pot, and an upper frame structure having at least one node between a grid arrangement of receptacles, at least one connection point formed the at least one node, an integrated irrigation system having at least one irrigation assembly comprising: a riser having a connection mechanism operable to connect to at least one connection point; an emitter operable to connect to an upper end of the riser, the emitter may have at least one bore providing a stream of fluid directed at a deflector having a surface pattern that diverts the stream into a plurality of deflected streams that delivers fluid toward each receptacle in the grid arrangement. The emitter may include a gantry structure overhanging the at least one bore and a deflector structure that may have a patterned surface. The bore may be aligned with the deflector such that the stream of fluid may strike the deflector. The pattern surface includes a plurality of facets that may divert the stream of fluid into the plurality of deflected streams. The deflector may be removably inserted in a recess in the gantry structure, and the system may include a plurality of interchangeable deflectors with different patterned surfaces. The riser may further comprise at least one irrigation conduit connector that is aligned with a structural member of the tray. The tray may further comprise an irrigation conduit in fluid communication with at least one irrigation conduit connector, wherein the irrigation conduit may not traverse any of the plurality of receptacles and may not otherwise obstruct an opening in the receptacles for insertion of the plant pot. The tray may further comprise an adapter clip for attachment to upper structural members of the upper frame structure and may have an upper connection structure operable to couple with the connection mechanism of the riser. The adapter clip may include flexible, resilient tabs operable to pressure fit on structural members of various diameters, providing an adaptable device for connecting the riser to planter trays of various designs. The adapter clip may include paired extensions that may have a tapering diameter between them to allow for pressure fitting on structural members of various diameters, providing an adaptable device for connecting the riser to planter trays of various designs. The riser may have a sufficient height to be positioned above the plant pot when the riser is attached to the connection point, and the plant pot may be inserted one of the receptacles.

In another aspect, the invention relates to a method of growing plants in pots in large scale, comprising: placing seeds or seedlings in a plurality of plant pots each having a pre-determined design; installing each of the plant pots into tray structure having a plurality of receptacles each with a complementary shape to the pre-determined design of the plant pots; connecting a riser to a riser connection point at a node on an upper frame structure of the tray, the node may be located between at least two of the receptacles; and a connecting a fluid emitter to an upper end of the riser, the fluid emitter may have at least one bore providing a stream of fluid directed at a deflector having a surface pattern that diverts the stream into a plurality of deflected streams that delivers fluid toward plant pots installed in each of the at least two receptacles. The emitter may include a gantry structure overhanging the at least one bore and a deflector structure having a patterned surface. The bore may be aligned with the deflector such that the stream of fluid strikes the deflector. The pattern surface may include a plurality of facets that divert the stream of fluid into the plurality of deflected streams. The deflector may be removably inserted in a recess of the gantry structure, and the system may include a plurality of interchangeable deflectors with different patterned surfaces. The riser may further comprise at least one irrigation conduit connector that may be aligned with a structural member of the tray. The irrigation conduit in fluid communication with the at least one irrigation conduit connector, wherein the irrigation conduit may not traverse any of the plurality of receptacles and may not otherwise obstruct an opening in the receptacles for insertion of the plant pot. The method may further be comprising attaching an adapter clip to a structural member of the upper frame structure, an adapter clip and having an upper connection structure operable to couple with the connection mechanism of the riser. The adapter clip may include flexible, resilient tabs operable to pressure fit on structural members of various diameters, providing an adaptable device for connecting the riser to planter trays of various designs. The adapter clip may include paired extensions having a tapering diameter between them to allow for pressure fitting on structural members of various diameters, providing an adaptable device for connecting the riser to planter trays of various designs. The riser may have a sufficient height to be positioned above the plant pot installed in one of the receptacles.

Further aspects and embodiments will be apparent to those having skill in the art from the description and disclosure provided herein.

It is an object of the present invention to provide a growing pot tray system with an integrated irrigation system.

It is a further object of the present invention to provide a growing pot tray system that allows the pots to be inserted and removed without having to remove or alter the integrated irrigation system.

It is a further object of the present invention to provide a growing pot tray system that allows growing pots to be inserted and removed with greater efficiency.

It is a further object of the present invention to provide a growing pot tray system having an integrated irrigation system having emitters that irrigate multiple pots and are located outside of the pots.

The above-described objects, advantages and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 provides a perspective view of a plant pot tray system, according to an embodiment of the present invention.

FIG. 2 provides a perspective side view of a plant pot tray system, according to an embodiment of the present invention.

FIG. 3 provides a perspective side view of a plant pot tray system, according to an embodiment of the present invention.

FIG. 4 provides a rear perspective view of a plant pot tray system, according to an embodiment of the present invention.

FIG. 5 provides a frontal perspective view of a plant pot tray system, according to an embodiment of the present invention.

FIG. 6 provides a top perspective view of a plant pot tray system, according to an embodiment of the present invention.

FIG. 7 provides a bottom perspective view of a plant pot tray system, according to an embodiment of the present invention.

FIG. 8 provides an environmental perspective view of a plant pot tray system, according to an embodiment of the present invention.

FIG. 9 provides an environmental perspective view of a plant pot tray system, according to an embodiment of the present invention.

FIG. 10 provides a side perspective view of a plant pot tray system, according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

The present invention concerns a plant pot holder tray for retaining multiple pots for plants therein, with the receptacles for receiving the pots plant. The pot tray may include an integrated irrigation system that may not install into the individual pots but may be installed into the tray itself outside of the pots. The integrated irrigation system allows for the pots to be installed and removed from the plant pot tray without disturbing the integrated irrigation system. In some embodiments, the plant pot tray of the present invention enables variously sized plant pots to be securely retained within the receptacles, as the receivers may have a tapered profile that is operable to receive pots of different designs that have tapering perimeter shape.

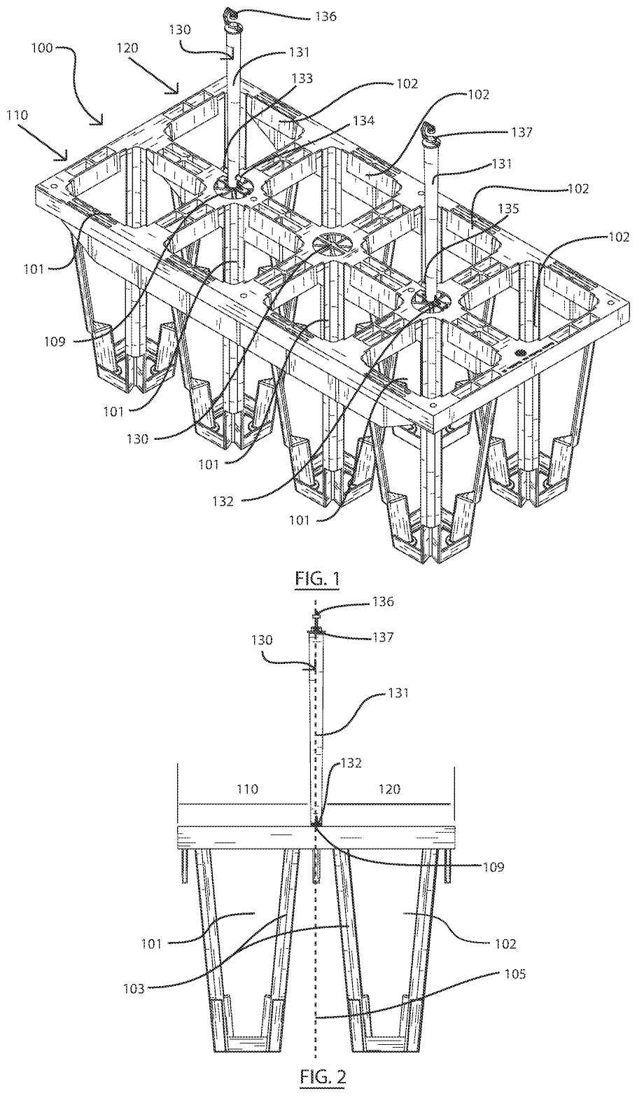

FIG. 1 shows an illustration of the plant pot holder tray 100 without any plant pots; the illustration is in an isometric perspective configuration. The tray 100 may have a plurality of plant pot receivers, 101, 102 and may include two rows 110 and 120. The tray may have a plurality of irrigation connection structures 109 at pre-determined location (e.g., nodes) in the upper frame. The irrigation connection structure 109 is illustrated as having a central location between adjacent plant pots 101, 102 and may be placed symmetrically between the first row 110 and second row 120. The irrigation structure connection structure 130 may be operable to receive an irrigation assembly 130. The irrigation assembly 130 may include a clip and adapter 132 (e.g., male end) for attaching to the irrigation connection structure 109 and a riser 131 may have an internal conduit for passing fluid to an emitting device 137 which may be attached to the upper end of each riser 131 to receiver and impact a deflector 136. The emitting device 137 may have a changeable nozzle, including bubblers, adjustable flow emitters, vortex emitters, and other types. The deflector 136 may redirect the fluid flow from the emitting device 137 into various streams and flows of fluid in directions tangent to the deflector 136. The irrigation assembly 130 may have a series of barbs 133, 134, and 135 operable to receive tubing for distributing flow to the riser 131.

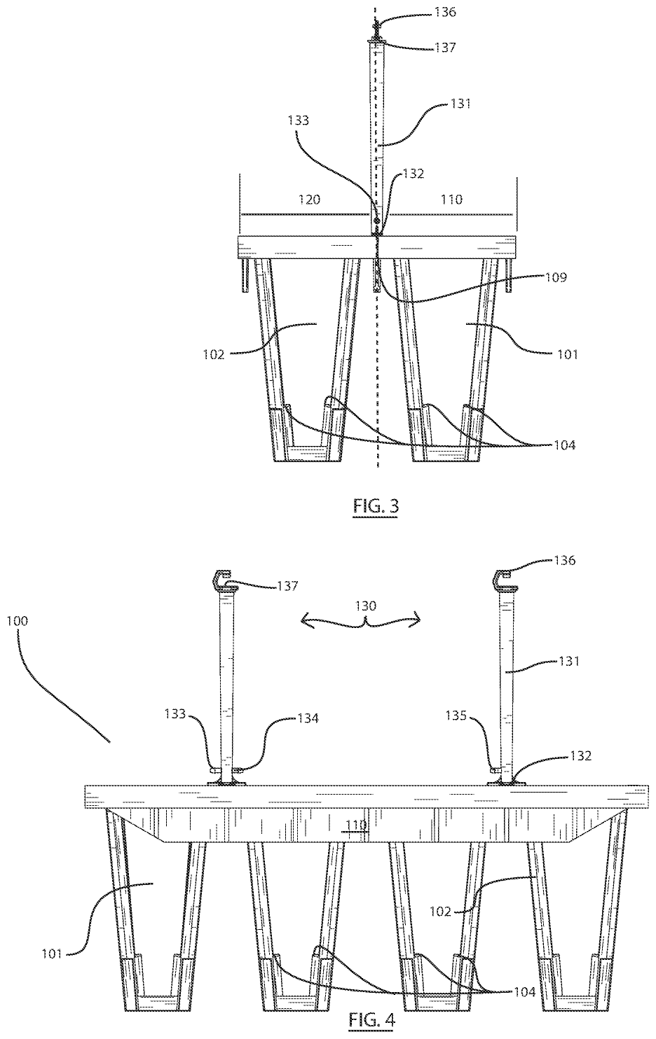

FIG. 2 shows a right-side view, and FIG. 3 shows a left-side view of the plant pot system 100 of FIG. 1. The plant pots have a first side 110 and a second side 120 for receiving a plant pot. The plant pot receivers 101, 102 may have a tapering structure 103 that may not be continuous but may be constructed to contact the four corners of a pot. The pot structure may have a shape that is complementary to a particular design of the pot. The tapering structure 103 may have an interior shelf 104 at the base operable to support the base of the plant pot leaving sufficient space for the growth of roots.

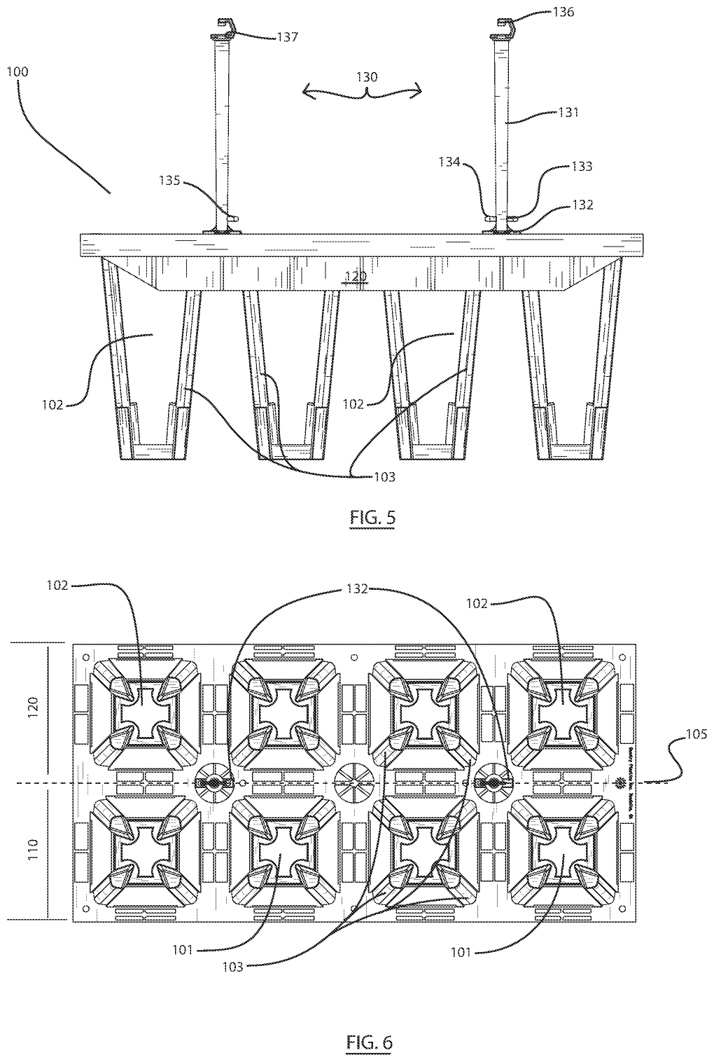

FIG. 4 shows a front side view and FIG. 5 shows a rear side view of the plant pot system of FIG. 1. The barbs of the irrigation assembly 130 may have connecting barb 133 for receiving tubing from a water source and pump, the barb 134 may be a coupling barb to receive an additional tube that is attached to a final barb 135 for distributing fluid up through the riser to the emitting device 137.

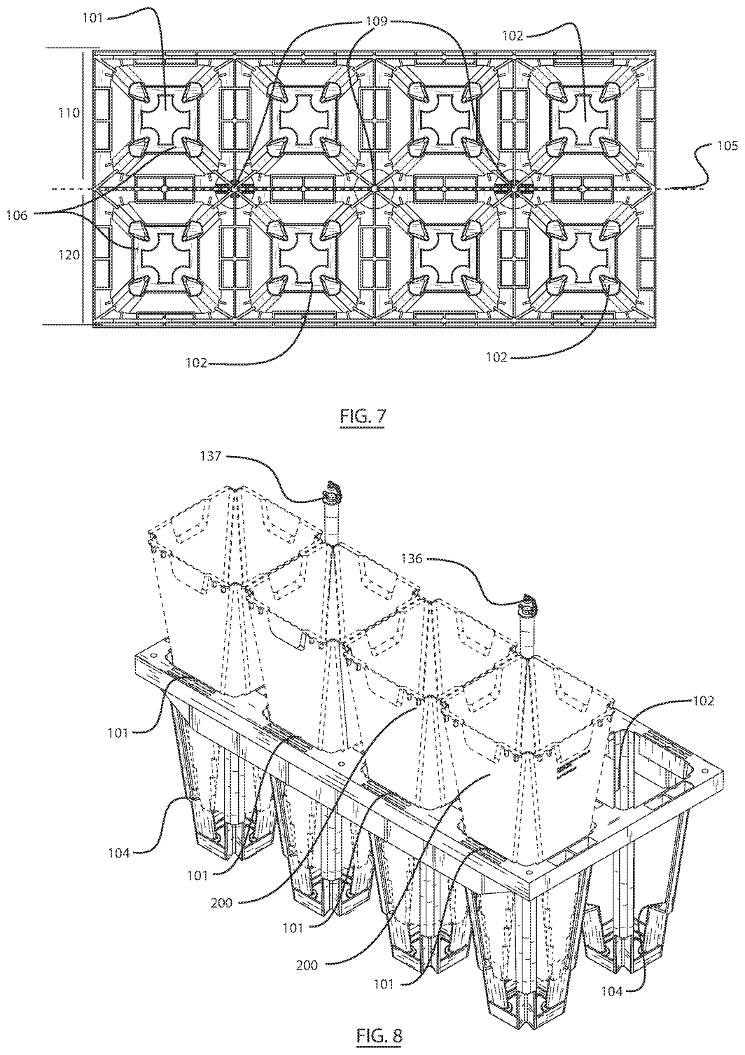

FIG. 6 shows a top view and FIG. 7 shows a bottom view of the plant pot system of FIG. 1. The plant pot system 100 (e.g., plant pot tray) may have a distribution of the plant pot receivers 101, 102 that may have the attribute of a grid. The plant pot receiver 101, 102 may be understood to be symmetrically placed about the node where the irrigation connection structure 109 may be concentrically placed about the node. The central irrigation connecting structure 109 (shown without the connecting structure) may demonstrate the criss-crossing beam structure operable to receive the irrigation assembly 130, the irrigation assembly 130 may be oriented at any 90° orientation with respect to the axis of symmetry 105, were the axis of symmetry 105 is 0° from the centroid of the structure. The irrigation clip and adapter 132 may utilize the various 90° orientations of the irrigation connecting structure 109 to clip and orient the irrigation assembly 130 to distribute fluid flow into the four pots arranged in the grid pattern of the plant pot tray 100. The tapering structure 103 of the plant pot receiver 101, 102 may have corners that have a curvature and complementary to the pot. The tapering structure 103 may culminate at the base 106 of plat pot tray 100.

FIG. 8 shows an exemplary perspective view of the plant pot system of FIG. 1 with an array of plant pots 200 nested in one row, the plant pot system 100. The plant pot 200 shows the complementary structure to that of the plant pot receivers 101, 102 and the base snuggly rested against the interior shelf 104.

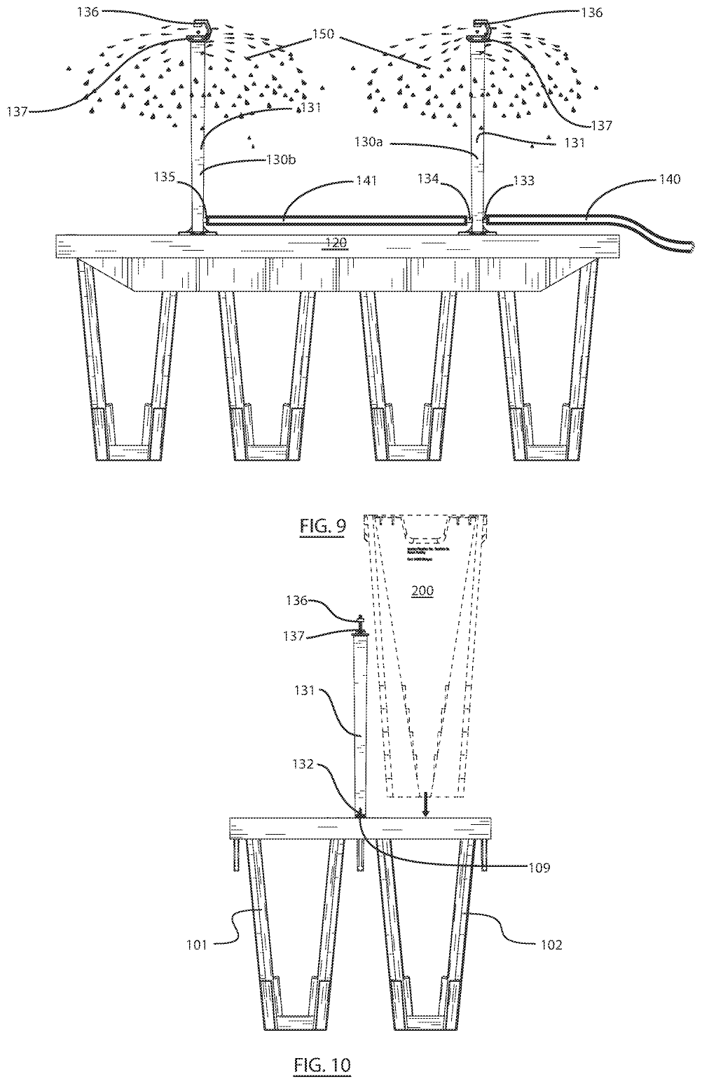

FIG. 9 shows an exemplary view of the plant pot system of FIG. 1, having the irrigation assembly 130a and 130b connected with a hose 141 and 140. The hose 140 may have an input of fluid flowing from a reservoir and pump system (e.g., water hose, irrigation pump, etc.). The first irrigation assembly 130a may have a receiving barb 133 and exit barb 134 for receiving the coupling hose 141 and may connect to a final barb 135 on the irrigation assembly 130b. The flow of fluid may be routed up the riser 131 and may flow out of the emitter 137 and impact the deflector 136. The deflector may redirect the flow of fluid 150 into a shape, where the shape may irrigate the adjacent plants around the node 109 where the irrigation assemblies 130 are placed.

FIG. 10. Shows an exemplary view of the plant pot system of FIG. 1 and shows a method of inserting a plant pot 200 into the plant pot tray receiver 102; an arrow indicates the direction of the plant pot 200 insertion. The plant pot may be inserted without interfering with the irrigation assembly 130; this is due to the nodal placement 109 of the irrigation assembly 130.

The present plant pot system 100 and grid of plant pot receivers 101 and 102 are capable of receiving a plant pot 200 without interfering with irrigation systems 130, of which may be operable to evenly distribute fluid to plants in the plant pot system 100. The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A plant pot tray system comprising:
a. a plurality of receptacles in a tray, each operable to hold a plant pot;
b. at least one connection point formed on a structural member of said tray between said plurality of receptacles
c. an integrated irrigation system having at least one irrigation assembly comprising:
i. a riser having a connection mechanism operable to connect to at least one connection point;
ii. an emitter operable to connect to an upper end of the riser, wherein said emitter has bore providing a stream of fluid directed at a deflector having a surface pattern that diverts the stream into a plurality of deflected streams in a pre-determined pattern that delivers fluid to said plurality of receptacles or plant pots installed in said receptacles.

2. The system of claim 1, wherein the emitter includes at least one bore for delivering a stream of fluid.

3. The system of claim 2, wherein said emitter includes a gantry structure overhanging the at least one bore and a deflector structure having a patterned surface, and said bore is aligned with said deflector such that said stream of fluid strikes said deflector.

4. (canceled)

5. The system of claim 4, wherein the pattern surface includes a plurality of facets that divert the stream of fluid into a plurality of deflected streams.

6. (canceled)

7. The system of claim 1, wherein the plurality of deflected streams are individually directed toward one of said plurality of receptacles.

8. (canceled)

9. The system of claim 8, further comprising an irrigation conduit in fluid communication with said at least one irrigation conduit connector, wherein said irrigation conduit does not traverse any of said plurality of receptacles and does not otherwise obstruct an opening in said receptacles for insertion of said plant pot.

10. The system of claim 1, further comprising an adapter clip for attachment to upper structural members of said tray and having an upper connection structure operable to couple with said connection mechanism of said riser, wherein said at least one connection point is located at a node of upper cross-beams of said tray between two or more of said plurality of receptacles.

11. (canceled)

12. (canceled)

13. (canceled)

14. (canceled)

15. A plant pot tray with an integrated irrigation system comprising:
a. a plurality of receptacles in a tray, each operable to hold a plant pot, and an upper frame structure having at least one node between a grid arrangement of said receptacles;
b. at least one connection point formed at said at least one node;
c. an integrated irrigation system having at least one irrigation assembly comprising:
i. a riser having a connection mechanism operable to connect to at least one connection point;
ii. an emitter operable to connect to an upper end of the riser, wherein said emitter has at least one bore providing a stream of fluid directed at a deflector having a surface pattern that diverts the stream into a plurality of deflected streams that delivers fluid toward each receptacle in said grid arrangement.

16. The tray of claim 15, wherein said emitter includes a gantry structure overhanging the at least one bore and a deflector structure having a patterned surface.

17. The tray of claim 16, wherein said bore is aligned with said deflector such that said stream of fluid strikes said deflector.

18. The tray of claim 17, wherein the pattern surface includes a plurality of facets that divert the stream of fluid into said plurality of deflected streams.

19. (canceled)

20. (canceled)

21. The tray of claim 20, further comprising an irrigation conduit in fluid communication with at least one irrigation conduit connector on said riser, wherein said irrigation conduit does not traverse any of said plurality of receptacles and does not otherwise obstruct an opening in said receptacles for insertion of said plant pot.

22. The tray of claim 15, further comprising an adapter clip for attachment to upper structural members of said upper frame structure and having an upper connection structure operable to couple with said connection mechanism of said riser.

23. (canceled)

24. (canceled)

25. The tray of claim 15, wherein said riser has a sufficient height to be positioned above said plant pot when said riser is attached to said connection point and said plant pot is inserted one of said receptacles.

26. A method of growing plants in pots in large scale, comprising:
a. placing seeds or seedlings in a plurality of plant pots each having a pre-determined design;
b. installing each of said plant pots into a tray structure having a plurality of receptacles each with a complementary shape to said pre-determined design of said plant pots;
c. connecting a riser to a riser connection point at a node on an upper frame structure of said tray, said node being located between at least two of said receptacles; and
d. connecting a fluid emitter to an upper end of said riser, said fluid emitter having at least one bore providing a stream of fluid directed at a deflector having a surface pattern that diverts the stream into a plurality of deflected streams that delivers fluid toward plant pots installed in each of said at least two receptacles.

27. The method of claim 26, wherein said emitter includes a gantry structure overhanging the at least one bore and a deflector structure having a patterned surface.

28. The method of claim 27, wherein said bore is aligned with said deflector such that said stream of fluid strikes said deflector, and the pattern surface includes a plurality of facets that divert the stream of fluid into said plurality of deflected streams.

29. (canceled)

30. (canceled)

31. The method of claim 26, wherein said riser further comprises at least one irrigation conduit connector that is aligned with a structural member of said tray.

32. The method of claim 31, wherein an irrigation conduit in fluid communication with said at least one irrigation conduit connector, wherein said irrigation conduit does not traverse any of said plurality of receptacles and does not otherwise obstruct an opening in said receptacles for insertion of said plant pot.

33. The method of claim 26, further comprising attaching an adapter clip to a structural member of said upper frame structure, said adapter clip and having an upper connection structure operable to couple with said connection mechanism of said riser.

34. (canceled)

35. (canceled)

36. (canceled)
